(19) United States
(12) Patent Application Publication
(10) Pub. No.: US 2004/0111347 A1
(43) Pub. Date: Jun. 10, 2004

(54) Methods and systems for business-to consumer marketing to promote and execute e-commerce transactions

(76) Inventors: John Julian Kauffman, Bloomington, IL (US); Dennis Ray Jones, Dacula, GA (US)

Correspondence Address: Michael S. Pavento, SUTHERLAND ASBILL & BRENNAN LLP, 999 Peachtree Street, NE, Atlanta, GA, 30309-3996, US

(21) Appl. No.: 10/299,974

(22) Filed: Nov. 19, 2002

(51) Int. Cl. G06F 17/60

(52) U.S. Cl. 705/36; 705/14

(57) ABSTRACT

Timely e-commerce transactions may be recommended to a subscriber. The subscriber's interaction with a computer may be monitored. In response to the monitoring, data elements may be collected and maintained representing the subscriber's interaction with the computer. The collected and maintained data elements may be analyzed to identify a consumer need of the subscriber. Based on the consumer need, the invention may trigger an event that may determine an event solution to the consumer need and offer the event solution to the subscriber. Resulting e-commerce transactions may be executed. Rule sets may be maintained that comprise a set of conditions that when satisfied identify an associated consumer need of the subscriber. The step of identifying the consumer need may comprise comparing said data elements against the set of conditions for each rule set to determine if each rule set is satisfied.

### TECHNICAL FIELD

The present invention relates generally to electronic commerce methods and systems for business-to-consumer marketing and customer relationship management programs. More specifically, the present invention relates to methods and systems for using automated event triggers to identify consumer needs and offer solutions to those needs in order to promote and execute e-commerce transactions.

### BACKGROUND OF THE INVENTION

The widespread adoption and acceptance of electronic commerce systems has profoundly affected the behavior of consumers and significantly expanded opportunities for improvement in business-to-consumer retail marketing. For example, many commercial Web sites seek to have users register in connection with the use thereof. Based on this registration process, Web sites routinely solicit e-mail addresses for registrants and permission to communicate future information and purchasing opportunities to such registrants by e-mail. Thus, registrants routinely receive periodic e-mails with information concerning promotions, purchasing opportunities, enhanced services, news updates and the like.

A host of additional communication modalities have arisen in response to the expanded computer infrastructure associated with the Internet. For example, chat rooms, message boards and mailing lists facilitate communications between users having common areas of interest. Individuals routinely utilize such forums to communicate and exchange views concerning investments (e.g., individual stocks, funds, etc.), hobbies, political issues, sports-related topics, and the like. Similarly, software messaging products permit individuals to communicate concerning issues of shared interest, while precluding access by interlopers.

A plethora of information on virtually any topic is also readily available over the Internet. Informational sites provide both current and historical content and, through hyperlink technology, allow users to “surf” from site to site in pursuit of understanding and knowledge. For example, the topics of family life improvement and household management are extremely well supported with information as is evident based on a recent Jupiter Research Report indicating that more than 1.5 million Web pages currently relate to such topics. In addition, the Web portal Yahoo lists more than 25,000 sites related to life improvement and household management on its search engine.

Yet, even with available tools and information resources, the challenges associated with personal and family household management remain daunting. Increasingly, individuals are attempting to exploit personal computer software applications, such as electronic planners, PDA's, calendaring programs, electronic messaging, etc., to help them manage their lives and the lives of their family members. And while these computer applications may prove useful in some areas, none prove useful in assisting consumers with the efficient acquisition of goods and services that they require. That is, they do not assist individuals or households with either the identification of their consumer needs or the execution of the transactions to acquire the products available to satisfy those needs.

In increasing numbers, individuals have turned to the Internet to purchase the goods and services they require. One of the key results of this trend is the steady increase in electronic commerce transactions. This result has, of course, magnified the importance of effective business-to-consumer marketing and advertising efforts in this new arena. However, the vast majority of the current e-commerce marketing methods are based on principles and strategies that have changed little since the inception of modern advertising in the 1920's. In spite of advances in consumer research and marketing technology and generalized scientific understanding of consumer psychology and buying behavior, suppliers still follow a “top down” approach to selling their goods and services: they start by mass-producing large quantities of product, add them to crowded distribution channels, create and promote a brand identity, and then seek to attract sufficient numbers of buyers within a limited time frame in order to realize a return on their investment and make a profit.

Internet e-commerce business models follow a similar approach by seeking to attract large numbers of visitors to their Web sites and employ a variety of techniques and gimmicks to ensure return visits and “stickiness” in hopes that a minority of interested prospects will “click through” to some type of sales opportunity and become repeat buyers. This approach produces consistently disappointing results for the vendor—typically less than one percent of prospects become new repeat customers as a result of unsolicited online marketing efforts, no matter how well “targeted” they appear. Unsolicited marketing efforts produce consumer avoidance and mistrust of vendors who have taken liberties with personal data and used this information to gain access to private realms such as email in order to make unsolicited offers for products and services that will not be of interest to over 99% of all recipients.

One of the key modules of conventional consumer marketing programs is the ability to predict the reactions of potential customers to products or services they have not yet purchased or sampled. Consumer marketers frequently rely on surrogate indicators to predict the preferences of groups of people, such as demographic or psychographic analysis. Demographic analysis assumes that people living in a particular region or who share similar objective attributes, such as household income, marital status, education, professional rank, sex or age, will have the same taste in products or services. Psychographic analysis tries to predict preferences based on scoring psychological tests. However, because these surrogates are based on non-product related factors they may perform poorly for individual tastes and needs.

Weighted vector-based collaborative filtering techniques allow consumers to rate items stored in a database, then for each consumer assemble a list of like-minded peers based on similar ratings. A peer's rating vector is weighted more heavily when the peer's preferences have greater similarity to the consumer's. The ratings of the highest weighted peers are then used as predictors for the items the consumer has not rated. These predictions can be sorted and presented as recommendations to the consumer. Such systems are incapable of recommending products or services that no one has rated, and may consume much time or memory if they must compare a consumer to many other consumers in order to get a sufficient number of predictions.

A second type of collaborative filtering technique computes the total number of exactly matching ratings two consumers have in common, and when this number exceeds a threshold the consumers are considered peers of each other. An item rated by a peer, but not by the consumer, has a prediction value equal to the peer's rating. This technique poses a trade-off: if the threshold is too high, the system may not be able to gather enough peers to make a prediction, and if the threshold is too low, the system may make predictions from peers not-very-similar to the consumer, making the predictions inaccurate.

A third type of collaborative filtering notes that there is often a relationship between items, i.e., a particular rating for one item may indicate a similar rating for another item. When a consumer rates one item, but not the other, the system uses that information to predict the rating for the other item. This technique works well when goods and services can be easily categorized; however in these circumstances objective filtering techniques may work as well. When items are hard to categorize, this technique will provide inaccurate predictions or no predictions at all. In sum, the basic fault of all of these marketing methods is that certain assumptions must be made to identify the target group, which may lead to inefficient marketing efforts or marketing efforts that do not reach the right targets. Such e-commerce marketing schemes become unsuccessful, wasteful or costly for suppliers.

Furthermore, individuals or household who turn to the internet on their own in an attempt to simplify their lives through the purchase of merchandise online may become dissatisfied with current industry practices. Consumers expect internet purchasing to provide cost-savings, convenience, greater product quality and selection, and personal shopping time efficiency. However, individuals quickly become frustrated by the inherent difficulties of searching the vast content of the internet for a particular item or solution to a need. Individuals may further become wary of trusting unknown suppliers with online orders or distrustful of providing information online that may be shared with other businesses. Finally, in the managing of their busy lives, these individuals may fail to realize that a particular need exists or fail to plan for a future need. This may lead to a failure to act or a failure to make good purchasing decisions once the need becomes apparent and the goods and service are hurriedly sought.

Based on the foregoing, there is a need, from both the perspective of the consumer and the business marketing to the consumer, for methods and systems which combine better household management/organizational tools with the convenience of e-commerce purchasing so that consumers are provided access to unique products or services which they have personally self-identified as needing, at the time those needs are experienced by the consumer.

### SUMMARY OF THE INVENTION

The present invention meets the needs described above by providing systems, methods, and computer readable media for recommending timely e-commerce transactions to a subscriber. According to certain embodiments, the invention may monitor the subscriber's interaction with a computer, wherein the interaction includes the subscriber's interaction with one or more life management program modules. In response to the monitoring, the invention may collect and maintain one or more data elements representing the subscriber's interaction with the computer, and may analyze the collected and maintained data elements to identify a consumer need of the subscriber. Based on the consumer need, the invention may trigger an event that may comprise determining an event solution to the consumer need and offering the event solution to the subscriber.

The event solution may comprise one or more solution products and a solution provider. The solution products may define a set of goods or services determined to satisfy the consumer need. The solution provider may define a provider of the set of goods or services. In accordance with one embodiment, the invention may execute any resulting e-commerce transaction relating to the offering of the event solution to the subscriber.

According to other embodiments, one or more life management program modules may be provided to the subscriber. The life management program modules may comprise a family organizer. The life management program modules may further comprise one or more change management tools.

According to other embodiments, rule sets may be maintained that comprise a set of conditions that when satisfied identify an associated consumer need of the subscriber. The step of identifying the consumer need may comprise comparing said one or more data elements against the set of conditions for each rule set to determine if each rule set is satisfied, and, for each rule set satisfied, determining that the associated consumer need has been identified.

The subscriber may further maintain a subscriber account that is sponsored by one or more sponsors and is affiliated with one or more alliance partners. The step of determining the event solution may comprise the steps of: 1) determining the sponsors and alliance partners of the subscriber account; 2) creating an event data string consisting of data elements identifying the identified consumer need, the subscriber, the sponsors, and the alliance partners; 3) maintaining subscriber databases that record subscriber data; 4) submitting the event data string to the subscriber databases; 5) determining the subscriber data that is relevant to the event data string; 6) appending the relevant subscriber data to the event data string; and 7) submitting the event data string with the appended relevant subscriber data to a commerce engine that maintains a plurality of commerce rules, wherein the commerce engine compares the event data string with appended relevant subscriber data to the plurality of commerce rules to determine the event solution.

The subscriber data may include subscriber profile data, subscriber event history data, and subscriber transaction history data. The subscriber profile data may include current profile data for the subscriber. The subscriber event history data may include records of past triggered events associated with the subscriber. The subscriber transaction history data may include records of past e-commerce transactions relating the event solutions previously offered to the subscriber.

In certain embodiments, the sponsor may sponsor the providing of the life management program modules to the subscriber. The sponsor may be a provider of goods or services. One of said commerce rules may require offering the goods or services of the sponsor to the subscriber where the goods or services provided by the sponsor are of the same type of good or services defined by the solution products. Further, the alliance partner may be a provider of goods or services. Another commerce rules may require offering the goods or services of the alliance partner to the subscriber where the goods or services provided by the alliance partner are of the same type of good or services defined by the solution products. In this case, the alliance partner may be required to pay a fee for having his goods or services offered to the subscriber in this manner.

In order to offer the event solution to the subscriber, certain embodiments of the invention may query the solution provider to determine the availability and price of the solution products, present the availability and the price information to the subscriber, and query the subscriber whether to proceed with purchasing said solution products based on the information presented. In order to execute any resulting e-commerce transactions, certain embodiments may consult the subscriber databases for transaction data that may include the subscriber's billing and shipping information, and then may transmit the transaction data to the solution provider.

In other embodiments, the step of offering the event solution to the subscriber may include providing an endorsement of the event solution from the sponsors or the alliance partners. The step of offering said event solution to the subscriber may include explaining to the subscriber the computer interaction that caused the consumer need to be identified. Further, the step of offering said event solution to the subscriber may also include incorporating at least one element of the relevant subscriber data into the offer such that the offer is unique to the subscriber.

These and other aspects, features and advantages of the present invention may be more clearly understood and appreciated from a review of the following detailed description of the disclosed embodiments.

### BRIEF DESCRIPTION OF THE DRAWINGS

FIG. 1 is a block diagram of a personal computer system, illustrating an exemplary operating environment for implementation of one or more illustrative embodiments of the present invention.

FIG. 2 is an exemplary high-level block diagram illustrating a system architecture in accordance with one or more exemplary embodiments as disclosed herein.

FIG. 3 is a high-level conceptual diagram demonstrating an exemplary client-side flow of information for a triggered event in accordance with one or more exemplary embodiments as disclosed herein.

FIG. 4 is a flow chart illustrating the method to fulfill a triggered event in accordance with one or more exemplary embodiments as disclosed herein.

FIG. 5 is a generalized interaction diagram illustrating the interaction between various system modules when an event is triggered in accordance with one or more exemplary embodiments as disclosed herein.

### DETAILED DESCRIPTION OF EXEMPLARY EMBODIMENTS

The present invention is directed to systems and methods for bringing businesses and consumers together in a mutually beneficial relationship. The present invention generally may provide consumers access to unique products or services, which they have self-identified as needing in order to accomplish their objectives, at the time those needs are experienced by the consumer. This may take place in the context of a pre-existing trust relationship with an established supplier in a manner that satisfies the needs of the buyers and sellers simultaneously. The present invention may thus empower consumers to efficiently purchase goods and services at the time they need them while enabling businesses to timely market the required goods and service to the consumers.

This is accomplished by recognizing that a consumer's computer interaction may be used to identify needs and assist in the efficient acquisition of the goods and services to fulfill those needs. Many consumers interact with their computers on a daily basis. This interaction often reflects much about the consumer's life, including, for example, important upcoming life events and dates, their daily routines, changes in family or financial status, as well as other significant happenings. Either directly or peripherally, almost all of these significant life events involve the need to acquire goods and services in some form. In certain embodiments, the current invention may provide systems and methods to identify and predict these consumer needs based on the consumer's interaction with his/her computer. In further embodiments, solutions to these identified consumer needs and providers for the solutions may be derived. The consumer (hereinafter “subscriber”) may then be presented via their computer with a useful suggestion identifying 1) the perceived need, 2) the solution to the need, and 3) how it may be obtained. The invention may then complete resulting e-commerce transactions.

More specifically, the present invention is directed to systems and methods for mapping the life activities of a subscriber. As used herein, “mapping the life activities of the subscriber” is defined as the monitoring of a subscriber's computer interaction, the determining of significant data associated with the interaction, and the recording of the significant data. In certain embodiments, the interaction that is monitored may take place on life management program modules that assist the subscriber with the organization and management of their life. Rule sets may be applied to the mapped data to identify subscriber's needs and trigger events based on those needs. The data associated with triggered events along with other subscriber information may be used to derive an solution that is unique and specifically tailored to the subscriber. Further embodiments of the present invention may provide methods and systems for offering to the subscriber the solution to the triggered event and executing any resulting e-commerce transaction.

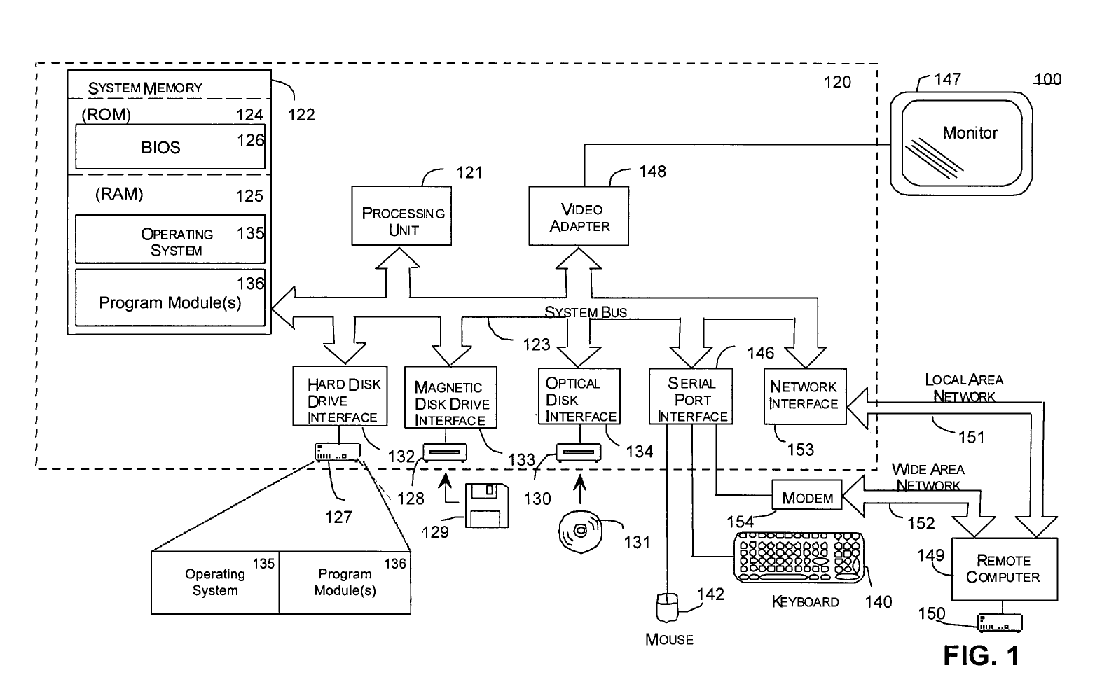

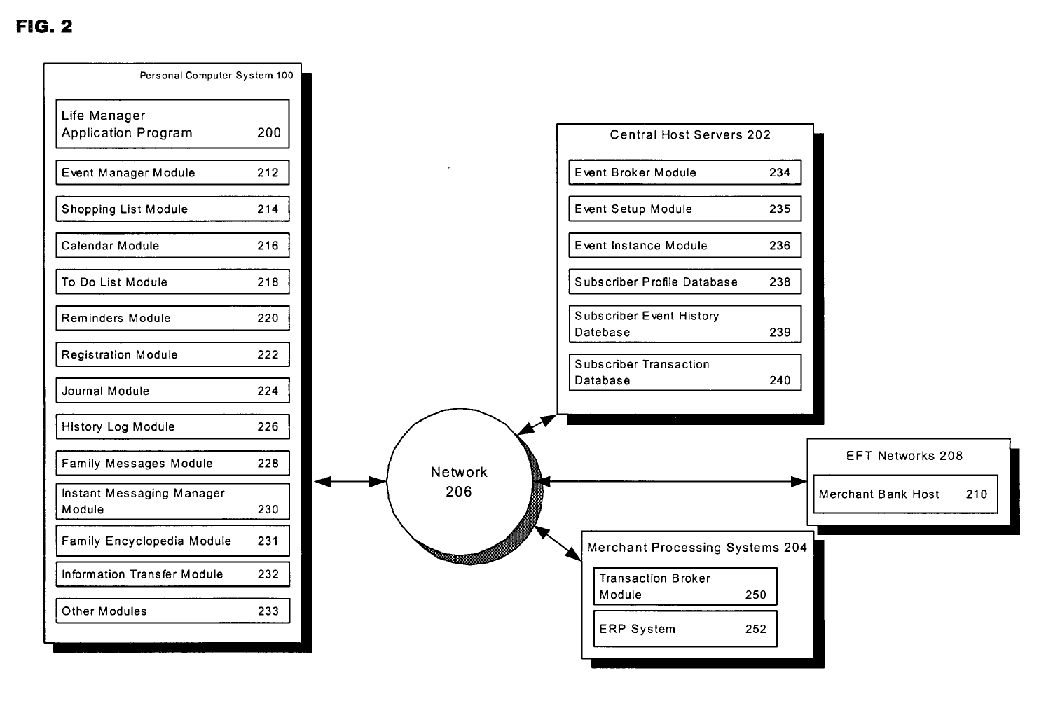

The following description will hereinafter refer to the drawings, in which like numerals indicate like elements throughout the several figures. FIG. 1 and the following discussion are intended to provide a brief and general description of a suitable computing environment for implementing the present invention. Although the system shown in FIG. 1 represents a conventional personal computer system 100, those skilled in the art will recognize that the invention also may be implemented using other types of computer system configurations. The computer system 100 may include a processing unit 121, a system memory 122 and a system bus 123 that couples the system memory 122 to the processing unit 121. The system memory 122 may include read only memory (ROM) 124 and random access memory (RAM) 125. A basic input/output system 126 (BIOS), containing basic routines that help to transfer information between elements within the personal computer system 100, such as during start-up, may be stored in ROM 124.

The personal computer system 100 may further include a hard disk drive 127, a magnetic disk drive 128, e.g., to read from or write to a removable disk 129, and an optical disk drive 130, e.g., for reading a CD-ROM disk 131 or to read from or write to other optical media. The hard disk drive 127, magnetic disk drive 128, and optical disk drive 130 may be connected to the system bus 123 by a hard disk drive interface 132, a magnetic disk drive interface 133, and an optical drive interface 134, respectively. The drives and their associated computer-readable media may provide nonvolatile storage for the personal computer system 100. Although the description of computer-readable media above refers to a hard disk, a removable magnetic disk and a CD-ROM disk, it should be appreciated by those skilled in the art that other types of media that are readable by a computer system, such as magnetic cassettes, flash memory cards, digital video disks, Bernoulli cartridges, and the like, may also be used in the exemplary operating environment.

System memory 122 and the various drives and their associated computer-readable media are all examples of memory storage devices. A number of program modules may be stored in one or more memory storage devices of the computer system 100, including an operating system 135 and one or more program modules 136. Generally, program modules may comprise computer-executable instructions stored on a computer-readable medium of the computer system 100. Program modules are also referred to herein generally as processes. The methods of the present invention may be implemented as one or more program modules as will be described below.

Other input devices (not shown) may include a microphone, joystick, game pad, satellite dish, scanner, or the like. These and other input devices are often connected to the processing unit 121 through a serial port interface 146 that is coupled to the system bus 123, but may be connected by other interfaces, such as a game port or a universal serial bus (USB). A display device 147 is also connected to the system bus 123 via an interface, such as a video adapter 148. In addition to a display device, personal computer systems typically include other peripheral output devices (not shown), such as speakers or printers.

The personal computer system 100 may operate in a networked environment using logical connections to one or more remote computer systems. A remote computer system 149 may be a server, a router, a peer device or other common network node, and typically includes many or all of the elements described above relative to the personal computer system 100, although only a storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets and the Internet.

When used in a LAN networking environment, the personal computer system 100 is connected to the LAN 151 through a network interface 153. When used in a WAN networking environment, the personal computer system 100 typically includes a modem 154 or other means for establishing communications over the WAN 152, such as the Internet. The modem 154, which may be internal or external, is connected to the system bus 123 via the serial port interface 146. In a networked environment, program modules depicted relative to the personal computer system 100, or portions thereof, may be stored in the remote memory storage device. It will be appreciated that the network connections shown are exemplary and other means of establishing a communications link between the computer systems may be used.

It will be further appreciated that the invention could equivalently be implemented on host or server computer systems other than personal computer systems, and could equivalently be transmitted to the host computer system by means other than a CD-ROM, for example, by way of the network connection interface 153. Those skilled in the art will appreciate that embodiments of the invention may be executed by many types of computer system configurations. These configurations could include, for example, a personal computer system or computer hardware devices, such as a home internet appliance, a hand-held device, a multi-processor system, a microprocessor-based or programmable consumer electronic device, a network PC, a minicomputer, a mainframe computer and the like.

FIG. 2 demonstrates an exemplary high-level system architecture for implementing one or more exemplary embodiments of the present invention. The system architecture, thus, may be configured to allow for the mapping of life activities of a subscriber based on the subscriber's interaction with his/her computer. A subscriber's computer interaction may include, for example, the inputting of personal calendar dates, “to do lists,” or profile information, as well as browsing activity or previous purchases, etc. Significant data related to these activities may be recorded and maintained by one or more program modules on the subscriber's computer. Certain rule sets may be applied to this data to identify consumer needs and trigger events. Data associated with the triggered event may be transmitted to a remote host server where it may be processed and a solution to the need (i.e., a set of the goods and services that satisfy the identified consumer need) may be derived. A merchant for the identified goods and services may also be determined. The systems and databases of the merchant may then be queried regarding the availability and price of the goods and services. This information may then be presented to the subscriber, the subscriber may be asked whether to proceed with the suggested transaction, and any resulting e-commerce transaction may then be completed.

As such, the system architecture may include a personal computer system 100 configured for executing a life manager application program 200, one or more central host servers 202, and one or more merchant processing systems 204 for running backend transaction processing. The life manager application program 200, the central host servers 202, and the merchant processing systems 204 may be connected via a network 206, i.e., a local area network and/or a wide area network such as the Internet. The system architecture may further include, but is not limited to, connectivity with a range of network servers in a variety of domains including the servers related to licensed Sponsors and Alliance Partners, as defined below, and associated services and suppliers, such as electronic funds transfer (EFT) networks 208 with systems of e-commerce merchant banking hosts 210.

The life manager application program 200 may reside on the personal computer system 100 of a subscriber. As used herein, a subscriber may be an individual, a family, a household, or other groups of individuals that may benefit from common organization or communication tools and may require consumer goods or services.

The life manager application program 200 is depicted as having several modules. As described, modules generally comprise computer-executable instructions stored on a computer-readable medium of a computer system. The modules associated with the life manager application program 200 may generally offer tools to the subscriber to organize or manage daily activities. The modules may further facilitate the submission of data by the subscriber, manage the submitted data, identify subscriber needs based on the submitted data, and trigger events based on the subscriber needs. Although the various modules are shown and described herein as separate modules, it can be readily appreciated by those skilled in the art that some or all of the modules may be combined into more complex modules, and/or separated even further into additional modules. Additional modules may also be apparent to those of ordinary skill in the art.

The modules of the life manager application program 200 may include an Event Manager Module 212. The Event Manager Module 212 may be a processing object which accepts and processes data related to the occurrence of an event. Generally, an event may occur when a predetermined set of conditions is satisfied. As used herein, an event may occur when a predetermined set of conditions is satisfied that signify the identification of a subscriber need. The “act of triggering an event” generally refers to the automatic launch of a program when an event has occurred so that a response may be generated. The “act of triggering an event,” as used herein, refers to the activation of automated processes to provide one or more solutions for the identified subscriber need. Thus, one or more of the life manager application program 200 modules may be configured to identify subscriber needs based upon the subscriber's interaction therewith, and the fulfillment of a set of conditions based on this interaction. The Event Manager Module 212, as described in more detail below, may receive the data associated with the triggered event from the identifying life manager application program 200 module, process the information, and manager transactional dialogue with modules of the central host servers 202 as necessary in the fulfillment of the triggered event, i.e., the providing of one or more solutions for the identified subscriber need.

As mentioned, the life manager application program 200 may contain several modules that provide useful tools to the subscriber in organizing and managing his/her life. These may include a suite of features to help a subscriber to communicate, schedule activities and appointments, keep track of things to do, manage financial resources, etc. Collectively and separately these features may be termed “life management program modules.” They may include, for example, a Shopping List Module 214, a Calendar Module 216, a To Do Lists Module 218, a Reminders Module 220, a Registration Module 222, a Journal Module 224, a History Log Module 226, a Family Messages Module 228, an Instant Messaging Manager Module 230, a Family Encyclopedia Module 231, and an Information Transfer Module 232. Other Modules 233 may be apparent to those skilled in the art to provide additional life management tools to the subscriber and/or to effectuate those tools already listed. For example, a module dedicated to assist the subscriber with the management of their financial resources may be created. This suite of features may become a “family organizer” when especially configured and formatted to assist a family or household with its organization, communication, and management.

In other embodiments, certain life management program modules may be configured as “change management modules” (not shown on FIG. 2). Change management modules may provide a suite of features and programs for assisting subscribers in making desired changes in their lives and managing the desired changes effectively. Thus, change management modules may provide one or more change management tools that enable subscribers to define and apply planning processes for achieving desired results in their lives. Change management tools may produce action plans for subscribers to engage in to achieve the results they have defined as desirable. Change management modules could be configured to interact with other life management program modules to assist a subscriber in the execution of these actions. For example, a change management module may interact with the calendar module 216 to post milestone dates or activities important to effectuating the life change desired. Further, the posting of events to the calendar module 216 by a change management module may be used to trigger events related to the posted activity.

Returning to the modules of the life manager application program 200, the Shopping List Module 214 may comprise a program to facilitate the subscriber's tracking and managing of his or her need for durable and non-durable goods. The Calendar Module 216 may provide a central calendaring program for the subscriber to schedule appointments, daily activities, and major life events. For instance, the Calendar Module 216 may keep track of important personal dates, such as anniversaries or birthdays, daily scheduled activities and appointments, as well as recurring obligations, such as regular car or home maintenance. The To Do Lists Module 218 may provide the subscriber a tool to organize and keep track of their “to do” lists. The Reminders Module 220 is a feature that may remind the subscriber at determined intervals before upcoming events of the Calendar Module 216 or items that may require attention per To Do Lists Module 218.

The Registration Module 222 may facilitate the registration of the new subscriber and may receive and store and maintain detailed subscriber profile data. The registration of new subscribers may be required to facilitate the subscriber's use of the life management tools and services associated with the life manager application program 200. The Journal Module 224 may facilitate the input of other important information concerning the subscriber such as important life events and happenings, i.e., the keeping of a subscriber journal. The History Log 226 may maintain a log of transactions and auditable actions that occurred within the life manager application program 200. The Family Messages Module 228 may comprise a center for sending and receiving messages between household or group subscribers. Instant Messaging Manager Module 230 may provide more real time messaging capabilities between members of a subscriber household. The Family Encyclopedia Module 231 may provide a central source for useful information that a subscriber household may need to function efficiently. This information may cover such topics as illnesses, pet care, landscaping, vehicle repair, entertainment, etc. The Information Transfer Module 232 may be a utility mechanism for transferring information between the life manager application program 200 and the central host servers 202 as necessary to effectuate the several functions described in more detail below.

All of the above modules, as well as other modules of the life manager application program 200 not shown or described herein, may have the ability to collect and maintain data elements based on the interaction of the subscriber with the modules of the life manager application program 200. These modules may maintain and have the ability to apply certain rule sets, i.e., conditions, to the collected data elements to determine if a subscriber need is identified and an event triggered. As used herein, a “subscriber need” may be defined as a consumer need that may be satisfied through the purchase of goods and/or services, and/or the provision of access to relevant supporting resources. For example, a rule set may be configured to determine whether a subscriber might be in need of or benefit from a Home Equity Loan based on his/her interaction with the life manager application program 200. The test conditions for such a rule set may include a combination of several of the following conditions: 1) a determination of whether the subscriber has accessed home maintenance resources as maintained on the Family Encyclopedia Module 231; 2) a determination of whether the subscriber has searched the internet for home remodeling contractors; 3) subscriber profile data as maintained on the Registration Module 222 indicating that the subscriber owns a home; 4) subscriber profile data indicating active balances on high-interest credit cards that could be consolidated at a lower interest; or 5) other relevant data elements. Any of these conditions when present may help to indicate the potential need for a Home Equity Loan. When one or more of the conditions are satisfied, it may be determined that there is a substantial likelihood that the subscriber need is predicted accurately.

It should be noted that the rule sets contained within the separate modules may access data elements collected and maintained in other modules of the life manager application program 200 to fulfill their stated conditions. That is, rule sets may require data elements maintained in more than one module (or from modules located at the central host servers 202 or other domains). One module may thus communicate with other modules to acquire the necessary data elements such that the stated conditions of the rule set may be tested. In alternative embodiments, rule sets may be maintained in a separate module to be applied to the data collected by the modules of the life manager application program 200. In other alternative embodiments, the data collected by the life manager application program 200 modules may be maintained in a separate database, and the rule sets (as maintained in either each module or a separate dedicated module) may then be applied to the data as kept in this separate database. Other such organizational modifications concerning the rule sets and the data elements collected may be apparent to those skilled in the art. Once the conditions of the rule set have been tested, an event may be triggered if certain conditions are satisfied. The triggered event may then be communicated to the Event Manager Module 212.

The central host servers 202 may include program modules, databases and servers maintained remotely from the subscriber. Although the various modules associated with the central host server 202 are shown and described herein as separate modules, it can be readily appreciated by those skilled in the art that some or all of the modules. may be combined into more complex modules, and/or separated even further into additional modules. The central host servers 202 may be configured for executing an Event Broker Module 234, an Event Setup Module 235, and an Event Instance Module 236. The Event Broker Module 234 may receive triggered event transactions via the network 206 from the life manager application program 200 (as described in more detail below), further process the triggered event, and manage the transaction dialogue between life manager application program 200 and the merchant processing systems 204.

The Event Instance Module 236 may provide a commerce engine wherein one or more commerce rules are maintained. Commerce rules may be rules and conditions that may be applied to the data elements associated with the triggered event (as processed by the Event Manager Module 212 and the Event Broker Module 234) to determine a solution to the triggered event (an “Event Solution”). The Event Solution may thus comprise a derived solution to the identified need of the subscriber based upon the commerce rules of the Event Instance Module 236. The commerce rules may further determine an appropriate merchant or provider that may supply the Event Solution to the subscriber (a “Solution Provider”). For example, a commerce rule may include a set of rules that take into account the data associated with the specific triggered event, the subscriber's sponsor/alliance partner profile (as defined below), the subscriber's profile and the subscriber's household profile, the location of the subscriber, the financial information associated with the subscriber, etc. Taking into account these type of variables associated with any given triggered event, the Event Instance Module 236 may derive the Event Solution and the Solution Provider.

The Event Set-up module 235 may provide the user interface and processing logic to create a new event, or make changes to an existing event. More specifically, the Event Set-up module 235 may be an system administrator function employed to add or modify existing rule sets at the modules of the life manager application program 200 or the commerce rules of the Event Instance Module. This module may consist of form based prompting for the necessary values which must be available for the activation and fulfillment of an triggered event.

The central host servers 202 may further comprise several databases including a Subscriber Profile database 238, a Subscriber Event History database 239, and a Subscriber Transaction History database 240, which collectively may be termed “subscriber databases.” The Subscriber Profile database 238 may maintain current profile data for each subscriber as provided by the subscriber during the registration process and subsequent interaction with the life manager application program 200. This information may be updated such that it reflects the most current data of the subscribers most recent interaction with the life manager application program 200. This profile data may include demographic, financial, psychographic, and interest information such as the subscriber's favorite activities and hobbies and may further include family background and history information, etc. A subset of the subscriber's information may reside in the Subscriber Profile database 238, where the full profile may reside in the Registration Module 222 on the life manager application program 200. The differences in the two may reflect privacy policies and subscriber opt-in status where the subscriber may choose the extent of which his personal data is released to the central host server 202.

The Subscriber Event History database 239 may maintain records of all triggered events related to a particular subscriber. The Subscriber Transaction History database 240 may maintain records of all resulting e-commerce transactions.

The merchant processing systems 204 may include computer systems configured to communicate and process transactions with one or more providers of goods and services, i.e., merchants. The merchant processing systems 204 may be maintained as part of the central host servers 202, or (as shown) it may be remotely maintained connected via the network 206. The merchant processing systems 204 may include a Transaction Broker Module 250. The Transaction Broker Module 250 may receive transaction data from the Event Broker Module 234 via the network 206 connection and translate the data to a protocol usable by a Merchant Enterprise Resource Planning system (ERP) 252. An ERP may be the processing systems and databases for a given merchant for managing inventory, price, and sales order processing. The Transaction Broker Module 250 may also receive information from the ERP 252 for communication back to the Event Broker Module 234.

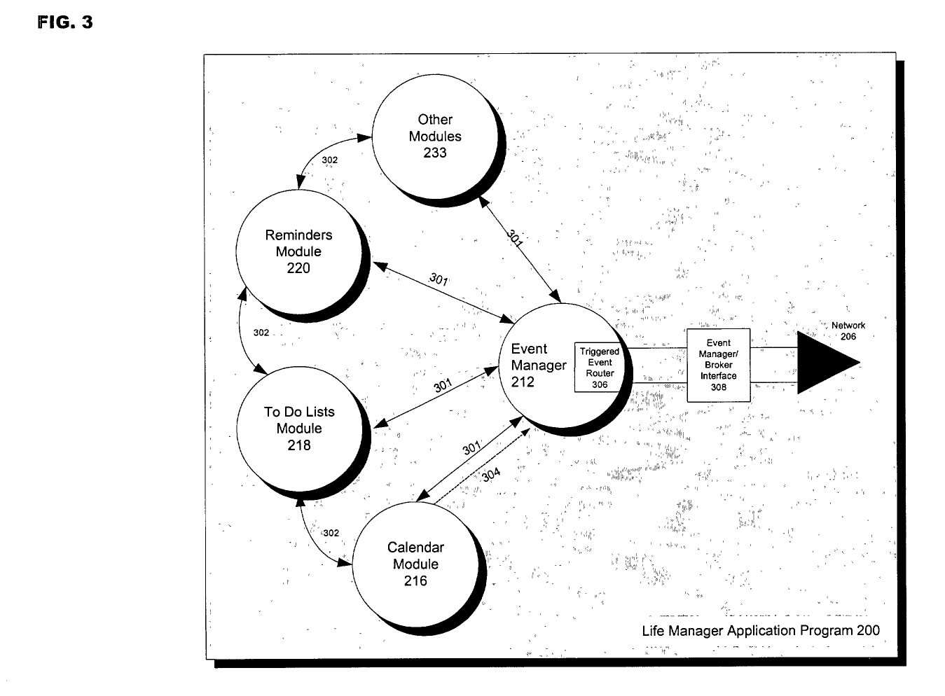

FIG. 3 demonstrates the interaction that may occur between the modules during the triggering of an event. The Event Manger 212 may be in communication with the several life manager application program 200 modules, as shown for the Reminders Module 220, the To Do Lists Module 218, the Calendar Module 216, and Other Modules 233. In operation, for example, the Calendar Module 216 may trigger an event based upon rule sets as maintained therein. As described, the rule sets may be applied to subscriber data maintained by the Calendar Module 216 and the other modules of the life manager application program 200. Thus, communication 302 may occur between the life manager application program 200 modules in transferring data necessary to test the conditions of a rule set. Upon the satisfaction of one or more the conditions of the rule set, an event may be triggered in the Calendar Module 216.

The Calendar Module 216 may then transmit 304 the triggered event to the Event Manager Module 212. The triggered event may be processed by the Event Manager Module 212, as discussed in more detail below, and transmitted by an Triggered Event Router 306 via the network 206 where it may be communicated to the Event Broker Module 234 at the central host servers 202. An Event Manager/Broker Interface 308 may facilitate communications between the Event Manager Module 212 and the Event Broker Module 234. The Event Manager/Broker Interface 308 may be located at either the life manager application program 200 (as shown) or the central host servers 202 to facilitate the necessary communication.

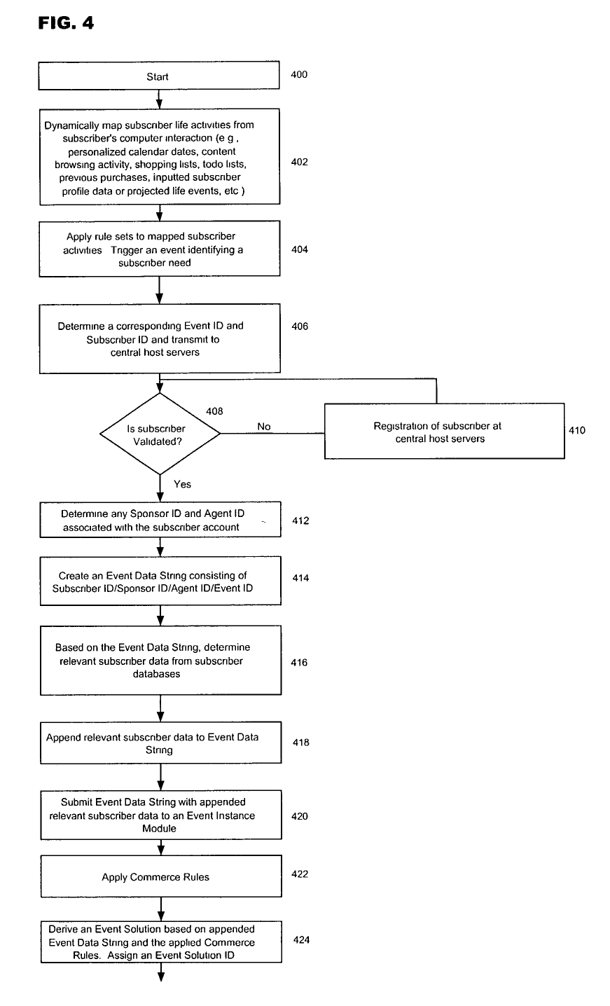

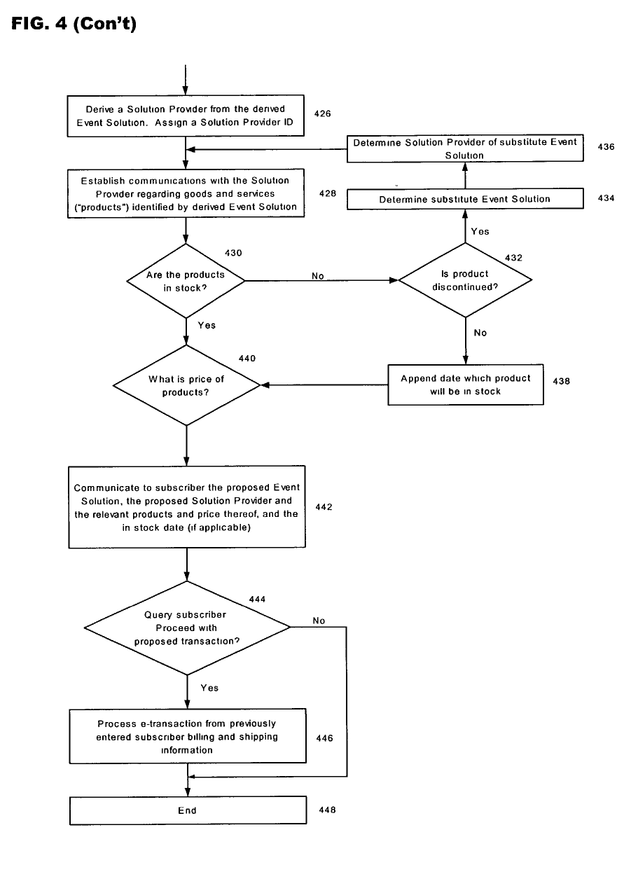

FIG. 4 is a flow chart illustrating an exemplary event trigger method. The method begins at start 400 and moves to step 402 where a subscriber's life activities are dynamically mapped based on the subscriber's interaction with his/her computer system. As stated, the “mapping of a subscriber's life activities” refers to a process of monitoring a subscriber's computer interaction, determining significant data associated with that interaction, and recording the significant data. “Dynamically mapping” refers to a process of updating a subscriber's records of significant computer interaction to reflect their ever changing consumer profiles. This process may include overwriting prior records to reflect more recent/relevant computer interaction and/or logically weighting the more recent interactions to indicate particular relevance or time sensitivity.

The dynamic mapping of the subscriber's life activities may include the monitoring of the subscriber's interaction with the different modules of life management application program 200. Significant data from a subscriber's computer interaction may include, for example, the subscriber's personalized calendar dates, content browsing activity, shopping lists, “to do” lists, previous purchases, inputted subscriber profile data or projected life events, etc. Of course, other subscriber interaction with the several organizational, communicational, and informational tools provided to the subscriber household by life manager application program 200 may also produce significant data that is used to update the subscriber's profile. As such, the life manager application program 200 may collect and maintain relevant and dynamic data elements that map the subscriber's life activities.

For example, a subscriber may be a household that includes a husband and wife that are expecting their first child. The birth of a child is a major life event for which much preparation and planning is necessary and many important decisions are made. Through the husband's and wife's interactions with their computer 100 and the life manager application program 200, data elements may be collected that relate to this major life happening. These might include the date elements related to the calendaring of doctor appointments, significant pregnancy milestones, or the baby's due date. These might include data elements related to searching the Family Encyclopedia Module 231 or the Internet for pregnancy health or child care information. These may also include data elements related to information entered by the husband or wife in the Journal Module 224 or Registration Module 222, relevant items entered in the To Do List 216, or any other interaction with their computer relevant to the birth of the child.

At step 404, the rule sets are applied to the data elements derived at step 402. Rule sets, as described, may be a set of conditions or business rules that once fulfilled, identify a subscriber need. As mentioned, a subscriber need may be defined as a consumer need that may be satisfied through the purchase of goods and/or services. Thus, applying the rule sets to the data elements may identify a subscriber need, which triggers an event. The event may be triggered at any module or sub-module of the life manager application program 200 (or in alternative embodiments, as discussed, a separated module where all rule sets may be maintained). The event may be represented by an Event ID, which may be an XML data string that describes the triggered event and the relating subscriber need. The Event ID may be transmitted by the identifying life manager application program 200 module to the Event Manager Module 212.

The Event Manager Module 212 may then process the Event ID and add to the XML data string a Subscriber ID which identifies the particular subscriber involved with the triggered event. Note the computer interaction of one subscriber may trigger events for themselves or other subscribers. The Subscriber ID identifies the subscriber for whom the event was triggered. The Event Manager Module may determine the Subscriber ID by consulting the Registration Module 222 where it may be maintained for all subscribers that use the particular life management application program 200. The Triggered Event Router 306 may transmit at 406 the XML data string containing the Event ID and the Subscriber ID to the central host servers 202. It should be noted that the use here of XML data strings for this function is exemplary only, other similar computer languages, standards or protocols may be used as appropriate, such as EDI, dot.Net, TCP/IP Sockets, SNA-3270 and/or LU6.2, MQ Series Messages, and/or any SQL statement delivered via middleware offerings of various vendors including Tuxedo, Sun Microsystems and/or Oracle.

To continue the above example of the expectant parents, the rule sets may be applied with the collected data elements. The rule sets may be configured to determine if a subscriber is expecting a baby, which would in turn identify subscriber needs, i.e., the need to prepare for the new child. This determination may be as simple as the Registration Module 222 monitoring to check if the subscriber has updated their information to indicate she is expecting a baby. Or, it may be as complex as the Life Manager Application Program 200 modules monitoring less obvious ways that the subscriber may indicate that she is expecting a baby, i.e., the content of her browser activity, prior purchases, calendar entries, etc. If certain of the conditions of the rules sets are satisfied, the event (the need to prepare for an upcoming birth of a child) may be triggered. It should be noted that a confirmation may or may not be completed with the subscriber to insure that the event was appropriately triggered and/or whether the subscriber desires to have the triggered event forwarded to the central host servers 202 for fulfillment. At step 406, the Event ID and the Subscriber ID is transmitted to the central host server 202, as described in more detail in the discussion associated with FIG. 3.

At step 408 the central host servers 202 may validate the subscriber based on the received Subscriber ID. Upon receiving the XML packet from the Event Manager Module 212, the Event Broker Module 234 may read the Subscriber ID from the XML packet and check subscriber databases maintained at the central host servers 202 to validate the subscriber, i.e., determine if the subscriber is already registered. If the subscriber is not validated, an error message may be returned to the Event Manager Module 212 of the particular life manager application program 200, and the subscriber may be asked to complete a registration process at step 410. From step 410, the validation process of step 408 may be repeated.

If the validation of the subscriber is successful at step 408, the method may proceed directly to step 412 where the Event Broker Module 234 may determine any Sponsor ID or Agent ID associated with the Subscriber ID. The Sponsor ID and the Agent ID associated with a particular Subscriber ID may be maintained in subscriber databases located at the central host servers 202. The Sponsor ID may identify one or more sponsors of the subscriber account. A sponsor may be a third-party provider of goods or services who sponsors, i.e. provides, the life manager application program 200 to existing or targeted customers. Sponsoring, as used herein, may mean that the sponsor pays a licensing fee for the right to provide the life manager application program 200 to its customers and/or may further pay for the costs of distributing the program to its customers. In exchange, any resulting e-commerce transactions conducted between the subscriber and the sponsor via the life manager application program 200 may then be exempt from commission charges. In this manner, the life manager application program 200 may be supplied to the subscribers via an existing trust relationship with a third party sponsor. In alternative embodiments, a sponsor may pay a license fee to have its business name, logo, trademark, products or other proprietary information displayed by the life manager application program 200.

The Agent ID may identify an alliance partner of the subscriber account. An alliance partner may be a provider of goods and services that has made their goods and services available to the subscriber through the life manager application program 200. Unlike sponsors, alliance partners may not be required to pay for program distribution costs or license fees. Alliance partners may, though, be charged commission fees based on the goods or services purchased from them through the subscriber account on the life manager application program 200. Having determined the Sponsor ID and the Agent ID, the Event Broker Module 234 may then create an Event Data String that includes Subscriber ID/Event ID/Sponsor ID/Agent ID at step 414.

At step 416 the Event Broker Module 234 may query one or more databases based on the Event Data String and determine whether any data therein should be appended to the Event Data String based upon whether the information is relevant to the Event Data String. This may include querying the Subscriber Profile database 238, the Subscriber Event History database 239, the Subscriber Transaction History database 240, and other subscriber databases as appropriate. At step 418, information determined to be relevant to the triggered event may be appended to the Event Data String. For example, for the expectant parents mentioned above, information relevant to the upcoming birth of child may include the parent's current level of life insurance coverage or savings plans, which may be maintained in the Subscriber Profile database 238. This information may be appended to the Event Data String as relevant to the triggered event.

At step 420, the Event Data String with any appended relevant subscriber data may be submitted to the Event Instance Module 235. At step 422, the commerce rules as maintained in the Event Instance Module 235 are applied to Event Data String with appended relevant subscriber data. Based on the applied commerce rules, an Event Solution (i.e., a set of products/services to fulfill the subscriber need) is determined at step 424 and identified with a corresponding Event Solution ID. Based on the Event Solution ID, the Event Instance Module 235 also derives at step 426 a Solution Provider (i.e., a provider of the identified products/services). The determination of the Solution Provider is based on the identified goods and services to be provided as well as the Sponsor ID and Agent ID. The Solution Provider is identified with a corresponding Solution Provider ID. The Event Instance Module 235 may append the Event Solution ID and the Solution Provider ID to the appended Event Data String and return the string to the Event Broker Module 234.

Returning to the example of the expectant parents, the application of the commerce rules to the appended Event Data String would likely result in the derivation of several independent Event Solutions to the triggered event (the need to prepare for the birth of a child). These may include actions that most parents might anticipate, such as the purchase of a child car seat, a crib, etc. It may further include other important considerations that parents often fail to realize or plan for properly, such as increasing their life insurance coverage to appropriate levels, planning for any necessary child care, determining the best methods and financial products to save for the child's future education, etc. The commerce rules also derives the appropriate Solution Provider based on the Event Solution and relevant Sponsor and Alliance Partner information. For example, if the sponsor of the subscriber account is a particular insurance company, that company may be determined to be the Solution Provider for life insurance products. In other embodiments, more than one Event Solution or Solution Provider may be presented as options to the subscriber as appropriate.

At step 428 the Event Broker Module 234 may receive the appended Event Data String from the Event Instance Module 235 and may proceed to establish communication with the identified Solution Provider regarding the products identified by the derived Event Solution. To accomplish this, the Event Broker Module 234 may query a database to determine the appropriate merchant processing system 204 and the appropriate Transaction Broker Module 250 to contact, which will depend on the identified Solution Provider. The Event Broker Module 234 may send the appended Event Data String to the identified Transaction Broker Module 250 via the network 206.

Using the identified Event Solution and Solution Provider of the appended Event Data String, the Transaction Broker Module 250 at step 430 may query the ERP 252 of the Solution Provider to determine whether the identified products are in stock and/or available. If the products are not in stock, the method may proceed to step 432 where the Transaction Broker Module 250 queries the ERP 252 to determine if the products are discontinued. If the products are discontinued, the Transaction Broker Module 250 at step 434 may send an appropriate response to the Event Broker Module 234, which may then communicate with the Event Instance Module 235 to determine a substitute Event Solution. A substitute Solution Provider may then be determined at step 436, and the Transaction Broker Module 250 may then begin again at step 428 to query the newly identified Solution Provider as to whether the products identified are in stock.

If it is determined at step 432 that the identified (not in stock) products are not discontinued, the method may proceed to step 438 where the method may determine a date on which the products will be in stock and available, and may append this date on the appended Event Data String. The method may then proceed to step 440 where the Transaction Broker Module 250 may query the ERP 252 to determine the price of the products.

If, on the other hand, the products were determined to be in stock at step 430, the method may proceed directly to step 440 where the Transaction Broker Module 250 may query the ERP 252 of the Solution Provider to determine the price of the identified products. As stated above, the appended Event Data String will have relevant information from subscriber databases that may assist in this pricing effort. For example, in the case where life insurance is being quoted, information such as the age, sex, etc., of the individual may be relevant. Thus, a more accurate quote may be provided, i.e., a quote that is specifically tailored to the subscriber.

The Transaction Broker Module 250 may then append the relevant pricing information to the appended Event Data String and transmit it the Event Broker Module 234, which may then transmit the data to the Event Manager Module 212 at the life manager application program 200 where it may be communicated to the subscriber at step 442. Thus, the subscriber may be presented with a self-identified need (for which he may or may not have been aware) and a proposed solution complete with a supplier and information regarding whether the product is in stock and price. The proposed solution may further be offered to the subscriber with an endorsement from either the sponsor or a particular alliance partner to the subscriber account. The subscriber may be presented with a single proposed solution from a single provider for each triggered event. Or, the subscriber may be presented with several proposed solutions from different providers for each triggered event with complete pricing and stocking information. Multiple Event Solutions may be queued in order depending on importance or some may be held and presented at a more relevant time, i.e., when the subscriber is more aware of the need or the need is particularly pressing.

Thus, the expectant parents mentioned above may be presented with an Event Solution concerning the appropriate levels of life insurance. The Event Solution may take into account relevant subscriber information, such as their current level of life insurance coverage, so that the offer is unique and specifically tailored to the expectant parents situation. The Event Solution may be presented in the form of advice or a daily suggestion which informs the subscriber of appropriate levels, notifies them as to their level of coverage, and provides a quote from an insurance company to increase their coverage to the appropriate level. Given the relatively long lead time for securing life insurance, this Event Solution may be given a high importance rating and, thus, may be shown promptly to the subscriber. Other Event Solutions, such as the suggested purchase of a recommended child car seat, may be presented at a future date as appropriate, i.e., closer to the baby's due date when the need is more pressing. The offering of the proposed e-commerce transaction may take a multiplicity of forms. Along with the pricing information and availability of the item, the subscriber may be offered incentives to promote the transaction. These may include computer printed coupons, special discounts from sponsors, reward points, time-limited offers, etc.

At step 444 the subscriber is queried as to whether to proceed with the proposed transaction. The subscriber may also be presented with several options not demonstrated in FIG. 4, including an option to request further information concerning the products proposed or an explanation for the triggered event, i.e., why the subscriber need was perceived. If the subscriber decides to proceed with the proposed transaction, the transaction may then be processed automatically from previously entered billing and shipping data per electronic commerce methods commonly known in the art at step 446. If the subscriber decides not to proceed with the proposed transaction or after the transaction is completed, the method may continue to the end 448.

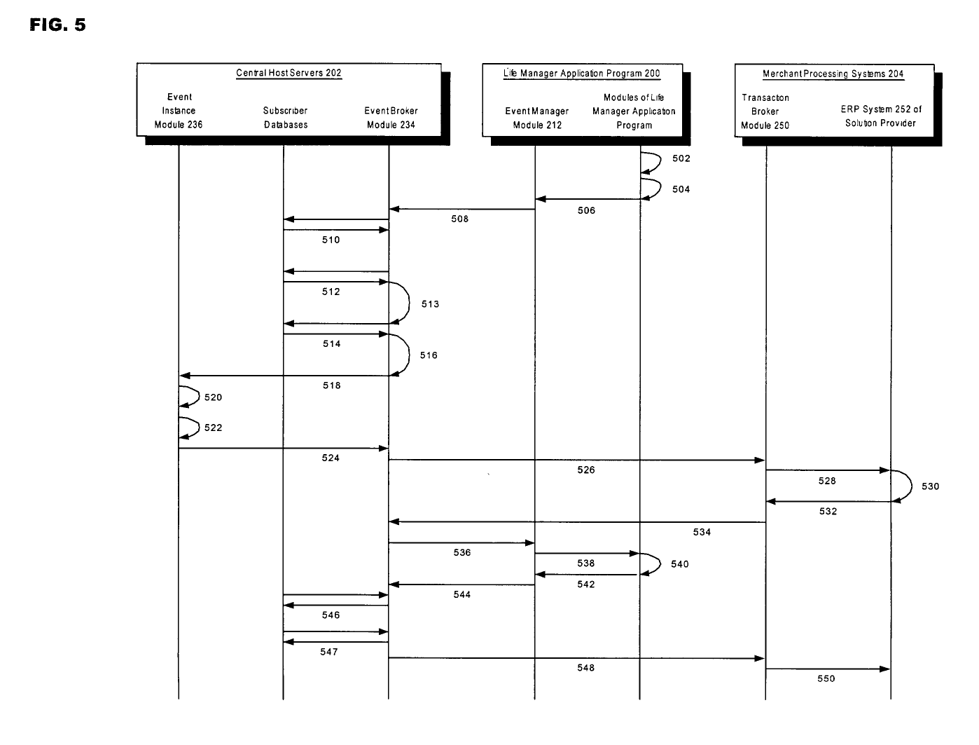

FIG. 5 is a generalized interaction diagram illustrating the interaction and flow of data between various system modules and databases. At 502, the modules of the life manager application program 200 dynamically maps the subscriber's life activities based on the subscriber's interaction with his/her computer system and the life manager application program 200. As mentioned, this may include, for example, the monitoring of interaction and recording of significant data from the subscriber's personalized calendar dates, content browsing activity, shopping lists, “to do” lists, previous purchases, inputted subscriber profile data or projected life events, etc. Thus, the modules of the life manager application program 200 may collect and maintain relevant and dynamic data elements that map the subscriber life activities.

At 504, the modules of the life manager application program 200 may apply one or more rule sets to the data elements collected at 502. Rule sets, as described, may be a set of conditions or business rules that once fulfilled, identify a subscriber need. Thus, at step 504, the application of rule sets to the collected data elements may identify a subscriber need, thus, triggering an event. At 506 the triggered event (being represented by an Event ID) may be transmitted to the Event Manager Module 212 of the life manager application program 200. The Event Manager Module 212 may then process the Event ID and determine a Subscriber ID which identifies the particular subscriber involved with the event, as described in more detail above. At 508 the Triggered Event Router 306 of the Event Manager Module 212 may transmit an XML data string containing the Event ID and the Subscriber ID to the Event Broker Module 234 at the central host servers 202.

At 510 the central host servers 202 may validate the subscriber based on the received Subscriber ID by checking subscriber databases maintained at the central host servers 202 and determining whether the subscriber is already registered. Subscriber databases as used with FIG. 5 may refer to any database maintained at the central host servers 202 that store subscriber information including, but not limited to, the Subscriber Profile database 238, Subscriber Event History database 239, and the Subscriber Transaction History database 240. If the validation of the subscriber is successful, the Event Broker Module 234 may determine a Sponsor ID and an Agent ID at 512 by again referencing the subscriber databases. At 513 the Event Broker Module 234 may then create an Event Data String to include Subscriber ID/Event ID/Sponsor ID/Agent ID.

At 514 the Event Broker Module 234 may, based on the Event Data String, query the subscriber databases and a determination may be made as to whether any data therein should be appended to the Event Data String based upon whether the information is relevant to the triggered event. This may include querying the Subscriber Profile database 238, Subscriber Event History database 239, the Subscriber Transaction History database 240, and other subscriber databases. At 516 the Event Broker Module 234 may append any information determined to be relevant to the triggered event to the Event Data String.

At 518 the Event Data String with appended relevant subscriber data may be submitted to the Event Instance Module 235. At 520 the commerce rules as maintained in the Event Instance Module 235 may be applied. Based on the application of the commerce rules to the appended Event Data String, an Event Solution (i.e., a set of products/services to fulfill the subscriber need) is derived and identified with a corresponding Event Solution ID. Based on the Event Solution, the Event Instance Module 235 derives at 522 a Solution Provider (i.e., a provider of the products/services), which is identified with a corresponding Solution Provider ID. The Event Instance Module 235 may append the Event Solution ID and the Solution Provider ID to the appended Event Data String. At 524 the Event Instance Module may return the string to Event Broker Module 234.

At 526 the Event Broker Module 234 may transmit the appended Event Data String to the appropriate merchant processing system 204 and the appropriate Transaction Broker Module 250 that corresponds to the Solution Provider ID. At 528 the Transaction Broker Module 250 may then query the ERP 252 of the Solution Provider regarding the relevant products identified by the Event Solution ID. At 530 the ERP may determine whether the identified products are in stock, discontinued, and/or the price thereof. At 532 the ERP may transmit this information to the Transaction Broker Module 250. The Transaction Broker Module 250 may then append the relevant pricing information and stocking information to the appended Event Data String and transmit it the Event Broker Module 234 at 534.

At 536 the Event Broker Module 234 may then transmit the data to the Event Manager Module 212 at the life manager application program 200. At 538 the Event Manager Module 212 may transmit the data to the relevant modules of the life manager application program 200 such that the proposed transaction may be presented to the subscriber. At 540 the subscriber may be queried as to whether to proceed with the transaction.

If the subscriber does want to proceed, his acceptance may then be transmitted to the Event Manager Module 212 at 542 and then the Event Broker Module 234 at 544. The Event Broker Module 234 may again validate the subscriber at 546. If the validation is successful, the Event Broker Module 234 may then consult the subscriber databases for any necessary transaction data, such as subscriber billing and shipping information at 547. At 548 the acceptance and any necessary transaction data may be transmitted to the Transaction Broker Module 250, which may then transmit the acceptance to the ERP 252 of the Solution Provider at 550 where the e-commerce transaction may be completed.

Therefore, the foregoing is considered as illustrative only of the principles of the invention. The features and aspects of the present invention have been described or depicted by way of example only and are therefore not intended to be interpreted as required or essential elements of the invention. It should be understood that the foregoing relates only to certain exemplary embodiments of the invention, and that numerous changes and additions may be made thereto without departing from the spirit and scope of the invention as defined by any appended claims.

We claim:

1. A computer implemented method for recommending timely e-commerce transactions to a subscriber comprising the steps of:
monitoring the subscriber's interaction with a computer, wherein said interaction includes the subscriber's interaction with one or more life management program modules;
in response to the monitoring, collecting and maintaining one or more data elements representing the subscriber's interaction with said computer;
analyzing the collected and maintained data elements to identify a consumer need of the subscriber; and
triggering an event based on the consumer need, wherein triggering an event comprises determining an event solution to the consumer need and offering said event solution to the subscriber.

2. A computer readable medium having stored thereon computer executable instructions for performing the method of claim 1.

3. The method of claim 1, further comprising the step of executing any resulting e-commerce transaction relating to the offering of the event solution to the subscriber.

4. The method of claim 1, further comprising the step of providing said one or more life management program modules to said subscriber.

5. The method of claim 4, wherein said one or more life management program modules comprise one or more change management tools.

6. The method of claim 4, wherein said one or more life management program modules comprise a family organizer.

7. The method of claim 1, wherein said event solution comprises one or more solution products and a solution provider;
wherein said solution products define a set of goods or services determined to satisfy the consumer need; and
wherein said solution provider defines a provider of the set of goods or services.

8. The method of claim 7, further comprising the step of maintaining one or more rules sets, wherein each of said rule sets comprises a set of conditions that when satisfied identify an associated consumer need of the subscriber; and
wherein said identifying the consumer need comprises the steps of:
comparing said one or more data elements against the set of conditions for each rule set to determine if each rule set is satisfied;
for each rule set satisfied, determining that the associated consumer need has been identified.

9. A computer readable medium having stored thereon computer executable instructions for performing the method of claim 8.

10. The method of claim 1, wherein the subscriber maintains a subscriber account which is sponsored by one or more sponsors and is affiliated with one or more alliance partners;
wherein said determining the event solution comprises the steps of:
determining the sponsors of the subscriber account and determining the alliance partners of the subscriber account;
creating an event data string consisting of data elements identifying the identified consumer need, the subscriber, the sponsors of the subscriber account, and the alliance partners of the subscriber account;
maintaining one or more subscriber databases, wherein said subscriber databases record subscriber data;
submitting the event data string to said one or more subscriber databases;
determining the subscriber data that is relevant to the event data string;
appending said relevant subscriber data to the event data string; and
submitting the event data string with the appended relevant subscriber data to a commerce engine, wherein said commerce engine maintains a plurality of commerce rules, and wherein said commerce engine compares said event data string with appended relevant subscriber data to said plurality of commerce rules to determine the event solution to the identified consumer need.

11. A computer readable medium having stored thereon computer executable instructions for performing the method of claim 10.

12. The method of claim 10, wherein said subscriber data comprises subscriber profile data, subscriber event history data, and subscriber transaction history data;
wherein said subscriber profile data comprises current profile data for the subscriber, said subscriber event history data comprises records of one or more past triggered events associated with said subscriber, and said subscriber transaction history data comprises records of one or more past e-commerce transactions relating to the event solutions offered to the subscriber.

13. The method of claim 10, wherein said event solution comprises one or more solution products and a solution provider;
wherein said solution products define a set of goods or services determined to satisfy the consumer need; and
wherein said solution provider defines a provider of the set of goods or services.

14. The method of claim 13, further comprising the step of providing said one or more life management program modules to said subscriber;
wherein said one or more sponsors sponsors the providing of said one or more life management program modules to said subscriber.

15. The method of claim 14, wherein said sponsor is a provider of goods or services; and
wherein one of said commerce rules requires offering the goods or services of said sponsor to said subscriber where said goods or services provided by said sponsor are of the same type of good or services defined by said solution products.

16. The method of claim 13, wherein said alliance partner is a provider of goods or services;
wherein one of said commerce rules requires offering the goods or services of said alliance partner to said subscriber where said goods or services provided by said alliance partner are of the same type of good or services defined by said solution products; and
wherein said alliance partner pays a fee for having his goods or services offered to said subscriber in this manner.

17. The method of claim 13, wherein the step of offering the event solution to the subscriber comprises:
querying the solution provider to determine an availability of said solution products;
querying the solution provider to determine a price of said solution products;
presenting the availability and the price information to the subscriber; and
querying the subscriber whether to proceed with purchasing said solution products based on the information presented.

18. A computer readable medium having stored thereon computer executable instructions for performing the method of claim 17.

19. The method of claim 17, further comprising the step of executing any resulting e-commerce transaction relating to the offering of the event solution to the subscriber.

20. The method of claim 19, wherein said step of executing of any resulting e-commerce transaction comprises the steps of:
consulting said subscriber databases for transaction data, wherein said transaction data includes at least subscriber billing and shipping information; and
transmitting said transaction data to said solution provider.

21. The method of claim 10, wherein the step of offering said event solution to the subscriber includes providing an endorsement of the event solution from one of the sponsors.

22. The method of claim 10, wherein the step of offering said event solution to the subscriber includes providing an endorsement of the event solution from one of the alliance partners.

23. The method of claim 10, wherein the step of offering said event solution to the subscriber includes the step of explaining to the subscriber the computer interaction that caused the consumer need to be identified.

24. The method of claim 10, wherein the step of offering said event solution to the subscriber includes the step of incorporating at least one element of the relevant subscriber data into the offer such that the offer is unique to the subscriber.

25. A computer readable medium having stored thereon computer executable instructions for performing the method of claim 24.

26. A system for recommending timely e-commerce transactions to a subscriber comprising:
a network device having memory means and means for executing computer executable instructions;
a central server, in communication with said network device, having one or more databases and a second means for executing computer executable instructions; and
wherein said system is configured to execute computer executable instructions for:
monitoring the subscriber's interaction with said network device, wherein said interaction includes the subscriber's interaction with one or more life management program modules stored in said memory means;
in response to the monitoring, collecting and maintaining one or more data elements representing the subscriber's interaction with said network device;
analyzing the collected and maintained data elements to identifying a consumer need of the subscriber; and
triggering an event based on the consumer need, wherein triggering an event comprises querying at least one of said databases to determine an event solution to the consumer need and offering said event solution to the subscriber.

27. The system of claim 26, wherein said central server is in communication with one or more merchant servers; and
wherein said system is further configured to execute computer executable instructions for executing any resulting e-commerce transaction relating to the offering of the event solution to the subscriber.

28. The system of claim 26, wherein said one or more life management program modules comprises a family organizer.

29. The system of claim 26, wherein said event solution comprises one or more solution products and a solution provider;
wherein said solution products define a set of goods or services determined to satisfy the consumer need of the subscriber; and
wherein said solution provider defines a provider of the set of goods or services:

30. The system of claim 29, wherein one or more rules sets is maintained in said memory means, wherein each of said rule sets comprises a set of conditions that when satisfied identify an associated consumer need; and
wherein, in order to identify said consumer need, said system is further configured to execute computer executable instructions for:
comparing said one or more data elements against the set of conditions for each rule set to determine if each rule set is satisfied; and
for each rule set satisfied, determining that the associated consumer need has been identified.

31. The system of claim 26, wherein said one or more life management program modules stored in said memory means is sponsored by one or more sponsors and is affiliated with one or more alliance partners;
wherein one of said databases comprises a subscriber database, said subscriber database recording and maintaining subscriber data;
wherein one of said databases comprises a commerce rules database, said commerce rules database maintaining a plurality of commerce rules; and
wherein, in determining the event solution to the consumer need, said system is further configured to execute computer executable instructions for:
determining said sponsors;
determining said alliance partners. creating an event data string consisting of data elements identifying the identified consumer need, the subscriber, the sponsors, and the alliance partners;
submitting the event data string to said subscriber database;
determining the subscriber data that is relevant to the event data string;
appending said relevant subscriber data to the event data string; and
comparing said event data string with appended relevant subscriber data to said plurality of commerce rules to determine the event solution.

32. The system of claim 31, wherein said subscriber data comprises subscriber profile data, subscriber event history data, and subscriber transaction history data;
wherein said subscriber profile data comprises current profile data for the subscriber, said subscriber event history data comprises records of one or more past triggered events associated with said subscriber, and said subscriber transaction history data comprises records of one or more past e-commerce transactions relating to the event solutions offered to the subscriber.

33. The system of claim 31, wherein said event solution comprises one or more solution products and a solution provider;
wherein said solution products define a set of goods or services determined to satisfy the consumer need of the subscriber; and
wherein said solution provider defines a provider of the set of goods or services.

34. The system of claim 33, wherein said central server is in communication with one or more servers of said solution provider; and
wherein, in order to offer said event solution to the subscriber, said system is further configured to execute computer executable instructions for:
querying the servers of the solution provider to determine an availability of the said solution products;
querying the servers of the solution provider to determine a price of said solution products;
presenting the availability and the price information to the subscriber at the network device; and
querying the subscriber at the network device whether to proceed with purchasing the goods or services based on the information presented.

35. The system of claim 34, wherein said system is further configured to execute computer executable instructions for executing any resulting e-commerce transaction relating to the offering of the event solution to the subscriber.

36. The system of claim 35, wherein, in order to execute any resulting e-commerce transaction, said system is further configured to execute computer executable instructions for:
consulting the subscriber database for transaction data, wherein said transaction data includes at least subscriber billing and shipping information; and
transmitting said transaction data to said servers of the solution provider.

37. The system of claim 31, wherein, in order to offer said event solution to the subscriber, said system is further configured to execute computer executable instructions for providing at the network device an endorsement of the solution from one of the sponsors.

38. The system of claim 31, wherein, in order to offer said event solution to the subscriber, said system is further configured to execute computer executable instructions for explaining to the subscriber at the network device the computer interaction that caused the consumer need to be identified.

39. The system of claim 31, wherein, in order to offer said event solution to the subscriber, said system is further configured to execute computer executable instructions for incorporating at least one element of the relevant subscriber data into the offer such that the offer is unique to the subscriber.

40. A computer implemented method for recommending timely e-commerce transactions to a subscriber comprising the steps of:
receiving over a distributed network event data from a network device of the subscriber, wherein said event data comprises:
a first set of data identifying said subscriber;
a second set of data identifying a consumer need of the subscriber identified at the network device based on one or more data elements collected and maintained at the network device; wherein said data elements represent the subscriber's interaction with said network device;
determining an event solution to the consumer need; and transmitting offer data to said network device, wherein said offer data offers said event solution to the subscriber on the network device.

41. A computer readable medium having stored thereon computer executable instructions for performing the method of claim 40.

42. The method of claim 40, further comprising the step of executing any resulting e-commerce transaction relating to the offering of said event solution to the subscriber.

43. The method of claim 40, wherein said subscriber is sponsored by one or more sponsors and affiliated to one or more alliance partners;
further comprising the steps of:
maintaining one or more subscriber databases, wherein one of said subscriber databases maintains sponsor and alliance partner information for each subscriber, and wherein one of said subscriber databases maintains subscriber data; and
determining said sponsor and alliance partner information for said event data based on said first set of data identifying said subscriber;
wherein said step of determining the event solution to the consumer need comprises the steps of:
creating an event data string consisting of the data identifying the consumer need identified at the network device, the subscriber, the sponsors, and the alliance partners;
submitting the event data string to said one or more subscriber databases;
determining the subscriber data that is relevant to the event data string;
appending said relevant subscriber data to the event data string;
submitting the event data string with the appended relevant subscriber data to a commerce engine, wherein said commerce engine maintains a plurality of commerce rules, and wherein said commerce engine compares said event data string with appended relevant subscriber data to said plurality of commerce rules to determine the event solution to the identified consumer need.

44. The method of claim 43, wherein said subscriber data comprises subscriber profile data, subscriber event history data, and subscriber transaction history data;
wherein said subscriber profile data comprises current profile data for the subscriber, said subscriber event history data comprises records of one or more past triggered events associated with said subscriber, and said subscriber transaction history data comprises records of one or more past e-commerce transactions relating to the event solutions offered to the subscriber.

45. The method of claim 43, wherein said event solution comprises one or more solution products and a solution provider;
wherein said solution products define a set of goods or services determined to satisfy the consumer need; and
wherein said solution provider defines a provider of the set of goods or services.

46. The method of claim 45, further comprising the following steps:
querying the solution provider to determine an availability of the solution products; and
querying the solution provider to determine a price of the solution products;
wherein said offer data includes information regarding the availability and price of the solution products; and
wherein said offer data includes a query to the subscriber whether to proceed with purchasing the goods or services based on the provided availability and price information.

47. The method of claim 43, wherein the step of transmitting the offer data to said network device includes the step of incorporating at least one element of the relevant subscriber data into the offer data such that the offer is unique to the subscriber.
